(19) United States
(12) Patent Application Publication
(10) Pub. No.: US 2025/0313462 A1
(43) Pub. Date: Oct. 9, 2025

(54) HOT OXYGEN TECHNOLOGY FOR MULTI-FEED PARTIAL OXIDATION

(71) Applicants: Lawrence E. Bool, East Aurora, NY (US); Bradley D. Damstedt, Williamsville, NY (US)

(72) Inventors: Lawrence E. Bool, East Aurora, NY (US); Bradley D. Damstedt, Williamsville, NY (US)

(21) Appl. No.: 19/092,601

(22) Filed: Mar. 27, 2025

Related U.S. Application Data
(60) Provisional application No. 63/574,322, filed on Apr. 4, 2024.

(51) Int. Cl. C01B 3/36

(52) U.S. Cl. CPC C01B 3/363; C01B 2203/0255; C01B 2203/061; C01B 2203/068; C01B 2203/0811; C01B 2203/1241

(57) ABSTRACT

The invention relates to the unique operation of a partial oxidation (POx) system by enabling simultaneous injection of feeds with widely varying properties, including simultaneous injection of gas, liquid and solid feedstocks to the hot oxygen burner.

### PROVISIONAL TO UTILITY

The present application claims priority from U.S. Application Ser. No. 63/574,322, filed Apr. 4, 2024, which is incorporated by reference herein in its entirety.

### FIELD OF THE INVENTION

The present invention relates to hot oxygen burners (HOBs) capable of generating a high momentum reactive jet suitable for use as a partial oxidation burner. Specifically, this invention allows unique operation of a partial oxidation (POx) system by enabling simultaneous injection of feeds with widely varying properties, including simultaneous injection of gas, liquid and solid feedstocks to the HOB.

### BACKGROUND OF THE INVENTION

Although examples of multi-feed POx burners exist in the literature, operation of these burners will usually create operational and mechanical problems. For this reason, typical POx burners in current use are designed to use only a specific type of feedstock. For example, a burner could be designed to use natural gas as the feedstock and would not be capable of using a liquid feedstock or solid feedstock. Another POx burner can be designed to use a liquid feedstock but is not capable of using a gaseous feedstock or solid feedstock. This limitation disqualifies a system designed for a specific feedstock from potential operating scenarios that lead to higher product yield or throughput. Additionally, this limitation prevents adapting the system to favorable opportunities that may develop during the lifetime of the system.

Plants, such as the partial oxidation reactors/systems, used for producing syngas derived from hydrocarbon feed materials often operate within predetermined conditions that are based on an assumed set of characteristics. These characteristics typically include the characteristics of the feed material and the characteristics of the syngas product that are required for downstream conversion into a final product. Example of feed characteristics include physical state (gas/liquid/solid), temperature, composition, and pressure. When there is a change in the characteristics of the feed material (including inherent properties such as those listed above, but also extrinsic properties such as its feed rate), the operator usually is forced to discontinue operations and/or to install costly substitute methodology to accommodate the change. A partial oxidation system, for example, that is designed to operate with a gaseous feed typically must change the burner and feed system to accommodate feeds in other physical states. The change is often exclusive such that the new configuration does not allow use of the previous feedstock.

Exemplary HOB burner, capable of being utilized in the partial oxidation reactor/systems is shown in U.S. Pat. No. 5,266,024 assigned to the current applicant, and which is incorporated by reference in its entirety.

While examples of burners capable of using feeds of different characteristics for partial oxidation exist in the literature, they often have significant operating or design challenges that make use of the burner in industrial service unpractical. For example, U.S. Pat. No. 4,946,475 discloses a method where an oxidizing gas and a slurry (mixture of liquid and solids) is fed into a converging section to atomize the slurry. The initial droplet/oxidant mixture is fed into a second “accelerating” section where the gas accelerates faster than the droplets-leading to a second step of atomization. The result is a premixture of slurry droplets and oxidizing gas fed into a reactor. The second part of the teaching is the inclusion of a gaseous feed passage that is specifically angled such that the gas will contact the oxidizing stream/droplet mixture some distance away from the burner face. One of the drawbacks associated with this disclosure is the potential for flashback into the secondary atomization port. Specifically, if enough of the fuel evaporates during atomization a combustible mixture may form inside the burner. By comparison, in the present invention hot oxygen atomization takes place near the burner exit without the need (or desire) for a secondary accelerating section and it's associated potential risks. Further, while the U.S. Pat. No. 4,946,475 discloses the slow mixing between the oxidizing stream/droplet mixture and the “fuel” gas by use of the angled port, this configuration can lead to unstable operation and an increase in soot as hot furnace gasses can mix with the fuel gas causing cracking prior to mixing with the oxidizing stream/droplet mixture. In the present invention close proximity of the hot oxygen jet and the slurry feed point enhances atomization and mixing between the oxidant (hot oxygen) and the hydrocarbon feed streams. Since the hot oxygen stream is at an elevated temperature the close proximity of the slurry and hot oxygen feed and fast mixing further serves to enhance evaporation and reaction with improves flame stability. The high momentum of the hot oxygen also drives very fast mixing with any additional feeds stream (such as the fuel stream shown in U.S. Pat. No. 4,946,475) in order to prevent soot formation and enhance reaction efficiency.

U.S. Pat. No. 4,443,230 provides a method where feeds to a partial oxidation burner are arranged coaxial and annular. The oxidant flow is split into at least two different annular spaces so that as the oxidant flow is reduced (‘turn-down’) the velocity through at least one passage can be kept high enough to provide atomization and mixing with the slurry feed. A drawback to this burner configuration is that requiring multiple passages significantly complicates the control system and potentially burdens operators with additional decisions regarding burner operation. Additionally, extra care must be taken to ensure that none of the burner passages is ever exposed to the hot reactor environment without any type of oxidant flow or purge gas flow to avoid burner damage. In the present invention the gas momentum required to atomize the liquid/slurry is provided by a single oxidant port, thereby avoiding the operating complexity of the multi-passage design. This single oxidant port atomization is enabled by the very high momentum of the hot oxygen jet. Even when the burner load is ‘turned down’ to lower firing rates the momentum of the hot oxygen jet is sufficiently high to effectively atomize the slurry stream. Therefore, when the burner load is changed the operators are not required to change the passage which the gas flows down, or add an additional ‘purge’ gas.

U.S. Pat. No. 4,351,645 discloses a method where mixing between hydrocarbon feedstocks, including liquid/slurry and/or gaseous hydrocarbons, and oxidant is achieved by distributing one stream across a number of tubes in a tube bundle that is surrounded by a second flow of feed. More specifically, this document discloses a specific burner design to accomplish this. Drawbacks of this invention include the requirement to uniformly distribute the feedstocks across the multiple tube bundles to avoid formation of hot and cold spots in the burner, which could lead to burner damage, reactor damage and/or poor performance.

The present invention adds flexibility and operational efficiency to the methodology of producing hydrocarbon-derived syngas useful in producing products such as fuels. More specifically, the high momentum of the reactive jet produced by the HOB of the present invention enables a single burner to process multiple feedstock streams simultaneously. This overcomes the difficulties shown for previous designs by not requiring perfect distribution of feedstocks within the burner prior to interacting with the mixing jet, increasing system reliability by avoiding potential burner and reactor damage associated with lack of feedstock control or maldistribution of feedstocks leading to hotspots.

### BRIEF SUMMARY OF THE INVENTION

In one aspect of the present invention, a process of producing syngas is provided. The process includes:

introducing a carbonaceous feedstock comprising a combination of gas, liquid and solid components in various combinations into a partial oxidation reactor vessel, wherein the feedstock is contacted by a hot oxygen stream produced by a hot oxygen burner wherein said hot oxygen stream is high velocity and reactive to atomize a carbonaceous feedstock selected from gas, liquid or solids in various volumetric combinations and provided through one or more passages to the hot oxygen burner and partially oxidize the feedstock in the partial oxidation reactor, using said hot oxygen jet that has given values of its temperature, velocity, and O₂ content, at given partial oxidation conditions of temperature ranging from 1100° C. to 1650° C., residence time, pressure, specific oxygen consumption, ratio of oxygen in the hot oxygen jet used in the partial oxidation to the feed, and entrainment rate of the feedstock into the hot oxygen jet wherein the hot oxygen jet is produced by reaction of oxygen and fuel in said hot oxygen burner at an HSR ranging from 12 to 3 to produce syngas having given values of temperature, soot content, CH₄ content, and tar content.

### BRIEF DESCRIPTION OF THE FIGURES

FIG. 1 is a cross-sectional view of an HOB device that can produce a stream of hot oxygen useful in this invention.

FIG. 2A is a schematic example of a multi-feed hot oxygen POx burner in accordance with one embodiment of the invention wherein liquid/slurry is fed alongside a gaseous feed.

FIG. 2B is a schematic example of a multi-feed hot oxygen POx burner in accordance with one embodiment of the invention wherein liquid/slurry is fed alongside a gaseous feed in a different configuration of the HOB.

FIG. 3A is a schematic example of a multi-feed hot oxygen POx burner in accordance with one embodiment of the invention wherein multiple gaseous feedstock streams are supplied in a symmetric manner to the POx burner.

FIG. 3B is a schematic example of a multi-feed hot oxygen POx burner in accordance with one embodiment of the invention wherein multiple gaseous feedstock streams are supplied in an asymmetric manner to the POx burner.

FIG. 4 is a schematic example of a multi-feed hot oxygen POx burner in accordance with one embodiment of the invention wherein multiple gaseous feedstock streams are supplied alongside a liquid/slurry feedstock stream to the POx burner.

FIG. 5 is a graph of reactor temperature in a pilot-reactor operated at different ratio combinations of liquid and gaseous feedstocks.

FIG. 6 is a graph of methane slip for a natural gas only feed burner compared to a multi-feed burner operating on natural gas.

### DETAILED DESCRIPTION OF THE INVENTION

The present invention is useful for any application where combustible materials are oxidized either partially or completely. The invention is particularly useful in operations that convert hydrocarbon feedstocks, such as natural gas or biomass-derived bio-oil to useful hydrocarbon products such as (but not limited to) liquid fuel. The product stream produced by the present invention is a high temperature syngas (i.e., a mixture of hydrogen, carbon monoxide, carbon dioxide, methane, water and small amounts of sulfur) includes components that can be sold and used after purification, as well as products that can be used as reactants to produce other finished useful products that can then be sold and used (e.g. diesel, ethanol, methanol, etc.).

The primary aspect of this invention is the use of a high velocity, reactive, jet to drive atomization and mixing of various feedstocks without needing to resort to a complex burner design as shown in the prior art. Specifically, the mixing power of the jet is high enough that even after mixing/atomizing a first feedstock stream there is adequate mixing power to mix a second, or more, feedstock stream of different types. A secondary aspect of the invention is the ability to independently change the mixing power of the jet depending on the mixture of feedstocks in use at any given time. These aspects are described in more detail below.

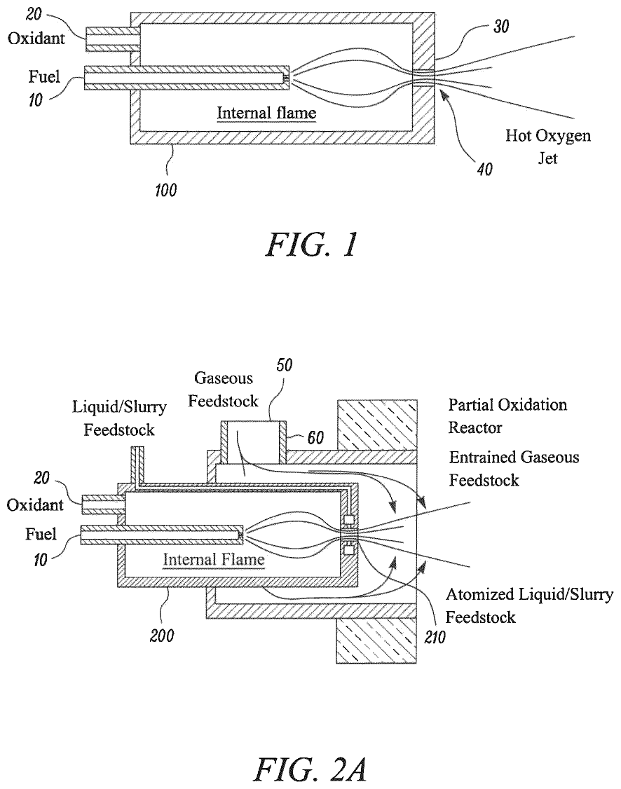

The fundamental part of the invention is the HOB shown in FIG. 1. The HOB 100 is a specially designed burner that produces a high temperature, high momentum jet containing oxygen. The jet is produced by combusting a small amount of fuel 10 with a large amount of oxygen 20 in a combustion chamber of the burner 100. The resulting gas mixture has an oxygen concentration ranging from 65-90% (along with some H₂O and/or CO₂ depending on the fuel being used) at temperatures ranging from 1000-2500° C. The “hot oxygen” mixture is then accelerated through a nozzle 30 to velocities ranging from 500-800 m/s. The overall effect is a highly reactive jet 40 with exceptional mixing and shearing capability. For example, the jet is capable of atomizing liquids while simultaneously entraining surrounding gases. The high O₂ content and high temperature make the jet very reactive, forcing all liquids, gases and solids drawn into the jet to rapidly react to produce the desired effect on the process.

One key benefit of HOB for gasification of liquid feeds is the ability to generate very fine droplets compared to conventional atomizers. The use of hot oxygen increases the gas momentum compared to ambient or ‘cold oxygen’ flow. The increased momentum results in a reduction in the mean droplet size after atomization. This combined effect of smaller droplets and higher local temperatures improves carbon conversion even at relatively short residence times. This type of HOB is utilized in U.S. Pat. Nos. 5,266,024; 6,450,108; and 6,565,010, assigned to the current applicant, and which are incorporated by reference in their entirety. The use of this type of HOB is a way to achieve excellent atomization and combustion for liquids, viscous liquids, slurries and sludges. Naturally, the HOB can be associated with a reactor in which the entrainment and gasification of the gas/liquid/solid feedstock combination can occur to form the syngas.

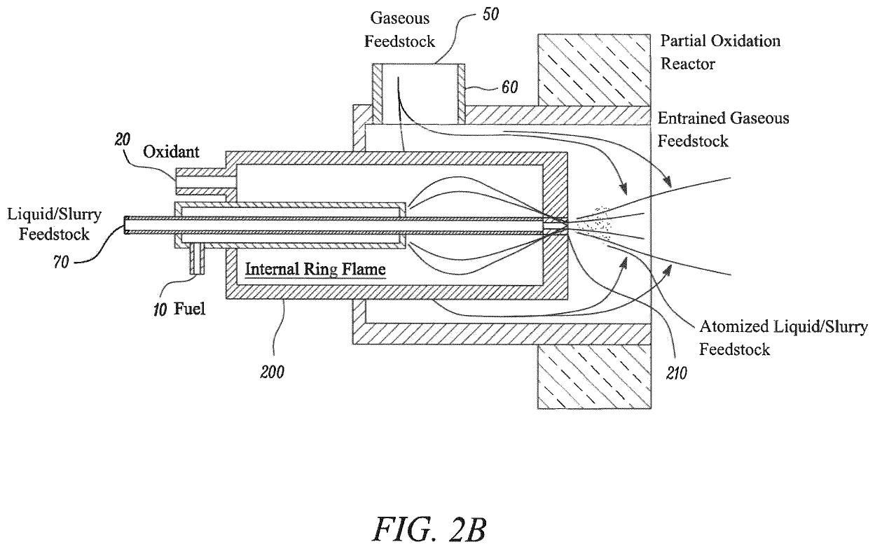

In an exemplary embodiment of the present invention, the HOB can be designed to atomize liquid feedstocks and still have remaining capacity to ensure sufficient entrainment of a gaseous feedstock. This is shown schematically in FIG. 2. An HOB 200 designed to atomize and react a liquid/slurry feed is arranged within a gaseous feedstock injector 60. As liquid enters the throat of the HOB 200 is it atomized to form a cloud of droplets surrounded by hot oxygen. The jet of hot oxygen/atomized liquid can then preferentially entrain a gaseous feed prior to mixing with hot reactor gases. Because the hot oxygen jet dominates the mixing, the arrangement between the hot oxygen jet and gaseous feedstocks is very flexible. FIG. 2 shows the gaseous feedstock injector 60 arranged axisymmetric to the HOB 200, but it can be reconfigured such that the feedstock can be introduced in a multitude of other ways, such as biasing the HOB location to one side of the feedstock injector, distributing to several individual injectors or locating the feedstock injection entirely separately from the HOB 200. Additionally, due to the high entrainment capacity of the hot oxygen jet, multiple gaseous feedstock injectors can be utilized with an HOB. For example, an additional gaseous injector can be included for use during warmup and continued to be used during normal operation as an injector for additional process gas feedstocks other than the primary design feedstock. The annular passage around the hot oxygen generator in FIG. 2A can also be employed to convey solid feedstocks, preferably solid feedstocks that have been fluidized, at least in part, by addition of some small amount of carrier gas. Preferably solid feeds would be located nearest the hot oxygen nozzle to avoid solid short circuiting of the reaction zone.

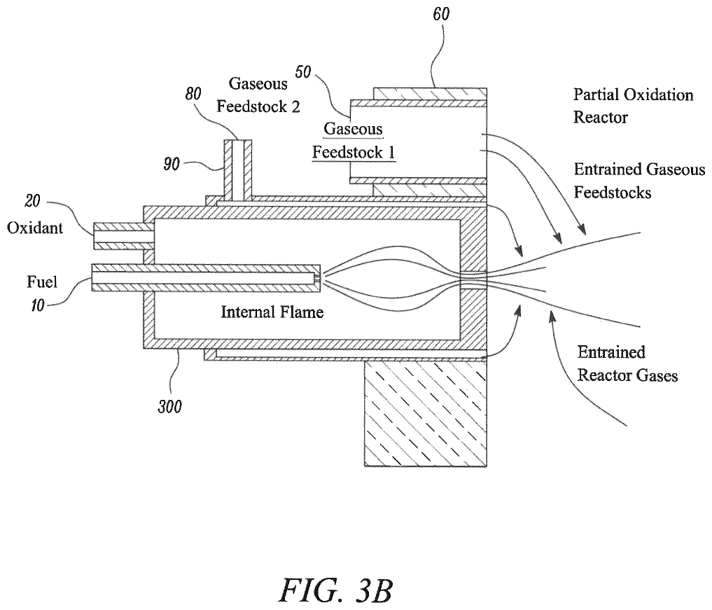

As described above the configuration shown in FIG. 2 can be used for gas and or solid feedstocks without requiring a liquid/slurry feed to be used at the same time. However, since the high momentum of the hot oxygen jet is ideal for atomizing liquids and slurries these feeds can be used in a burner shown in FIG. 2 by simply starting with the flow of liquid/slurry feeds. The liquid or slurry injector(s) should be arranged close to the hot oxygen nozzle to maximize the atomization potential and generate the smallest droplets possible. Those familiar with atomization will recognize the various methods of introducing liquids into a high momentum gaseous stream are also applicable here, adding another element of flexibility to the HOB design. For instance, FIG. 2 depicts a configuration where the hot oxygen burner is in the center and other feeds are introduced around the burner. However, those skilled in the art should know configurations could also be used where a feed port is in the center and the first annular space around the feed port is the hot oxygen burner (FIG. 4). Feed passed through the central port this configuration could be solids, liquids/slurries. Gaseous feeds could also be supplied through the central port, but preferably would be fed outside the hot oxygen annulus (i.e., between the hot oxygen and the furnace walls).

Thus, as shown in FIG. 2A and described above the HOB can be designed for use in only atomizing liquids/slurries, entraining only gaseous feedstocks, entraining only fluidized solid feedstocks, or for simultaneous processing of gaseous, solid, and liquid feedstocks in any combination.

Because the formation of the jet occurs inside the HOB, it is not influenced by external operating conditions. It is also independently operated, meaning jet properties such as temperature, composition and momentum can be adjusted to accommodate changes in the external operating conditions. This operational flexibility allows the operator to modify the reactive jet properties during operation. For example, if an HOB designed for gaseous feedstock at a internal stoichiometry (HSR) between 3 and 12, preferably 6 and 9, it may be desirable to increase the burner momentum when including a liquid feed. One method to do this is to increase the hot oxygen temperature by lowering the HSR. This adjustment is described in U.S. Patent Application No. 2023-0183063 A1 assigned to the current applicant, and which is incorporated by reference in its entirety. As used herein, “HSR” or “hot oxygen stoichiometric ratio” mean the ratio of moles of contained oxygen in the oxidant fed to the burner to the moles of oxygen that would be required to completely combust the fuel fed to the burner. As used herein, “total stoichiometric ratio” and “TSR” mean the ratio of moles of contained oxygen in the oxidant fed to the burner to the moles of oxygen that would be required to completely combust the total of the fuel fed to the burner, plus the auxiliary fuel, plus all combustible feeds fed to the reactor.

In accordance with one aspect of the invention, and with reference back to FIG. 2A, the HOB 200 has a fuel 10 and O₂ 20 feed, respectively, as discussed above. The HOB 200 is capable of processing a wide range of individual feedstocks or combination of feedstocks. For instance, the total feedstock can consist of gas, liquid, slurry, or solid feedstocks solely, or a combination of liquid/gas; liquid/solid; solid/gas or liquid and solid and gas feedstocks at or in the outlet of the HOB nozzle 210. The feedstocks of different physical states (solid, liquid, gas) can either be fed separately to the burner, for example through different flow passages, or may be combined prior to feed to the burner. For scenarios that utilize both solid and liquid feeds it is preferred, but not required, that the two streams be combined into a single ‘slurry’ stream prior to feed to the HOB. For scenarios with gaseous and solids feedstocks the solids can be fed as either a fluidized stream or a slurry in which the liquid phase may, or may not, be a hydrocarbon feed. The maximum size of the solid particle is defined based on the conversion of the solid in the POx reactor and final burner passage sizes. In general, any finely divided hydrocarbon-containing solid feedstock may be combined with hydrocarbon-containing liquid and/or gaseous feedstocks. For scenarios that utilize both liquid and gaseous feedstocks it is preferred that they be fed separately to the burner.

Examples of suitable raw feeds and their sources include:

Natural gas, from any commercial source thereof;
the gaseous stream that is produced by a gasification reactor, in which solid hydrocarbon material such as biomass or solid fuel such as coal or lignin is gasified in a stream of gas usually comprising air, steam, and/or oxygen at a high enough temperature that at least a portion of the solid material is converted to a gaseous raw stream;
product streams and byproduct streams, which more often are gaseous but may be liquid and/or solids, that are produced in a petrochemical refinery or chemical plant;
coke oven gas, being the offgas stream that is produced in a reactor that heat treats coal to produce coke;
pyrolysis gas, being a hydrocarbon-containing gaseous stream that is produced in a reactor to heat treat solid carbonaceous material such as fossil fuel or biomass to devolatilize and partially oxidize the solid material;

Other possible feed streams include oils, such as pyrolysis oils, and liquid hydrocarbons.

Gaseous feed streams typically exhibits a temperature of between about 33° F. and 1800° F. Solid feed streams are typically fed below a temperature at which the solid may begin to ‘soften’ or become sticky. In a representative example, feeds of high density polyethylene plastic materials may be kept below 180° F. to avoid sticking and feeding issues. Liquid feeds may be fed at temperatures up to their boiling point. Liquid feeds may be fed at any lower temperature where they can be pumped to the HOB.

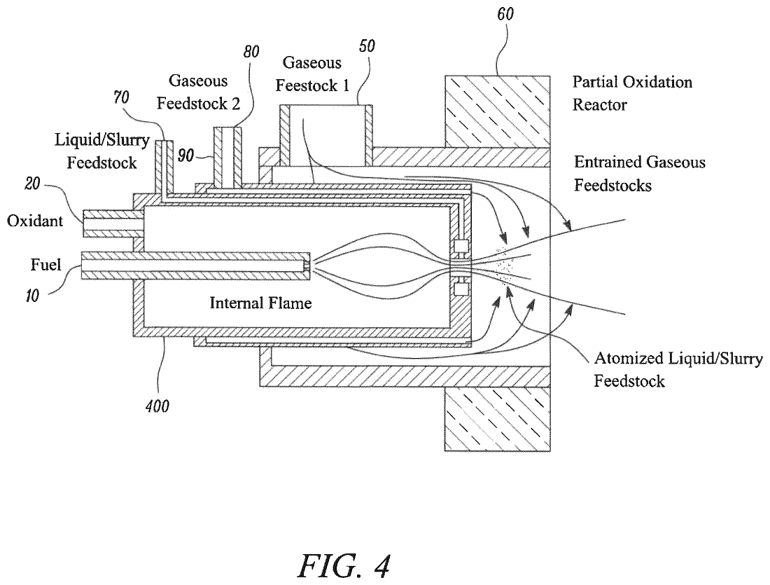

One particularly unique and useful operating feature of a multi feed HOB is the ability to operate using any ratio of feedstocks in a single burner. An HOB may operate with 100% gaseous feedstock then transition to 75% gaseous feedstock and 25% liquid feedstock then transition to 100% liquid feedstock. This is illustrated in FIG. 5, which shares data from a pilot scale experimental test. A single HOB was being used to gasify NG and bio-oil. The horizontal axis shows the proportion of bio-oil as a percentage of the combined bio-oil and NG feedstock being processed. The vertical axis is the operating temperature of the POx reaction vessel. The narrow range of temperatures shown is indicative of a single HOB's ability to very effectively gasify NG by itself, bio-oil by itself and any combination of NG and bio oil.

With reference to FIG. 2B, an alternative configuration to the HOB 200 is shown where the liquid or slurry feedstock 70 s introduced concentrically, and it is disposed internally to the hot oxygen stream where at the nozzle 210 the atomized feedstock is entrain the gaseous feedstock 50 routed to the exit of the nozzle 210 in the partial oxidation reactor.

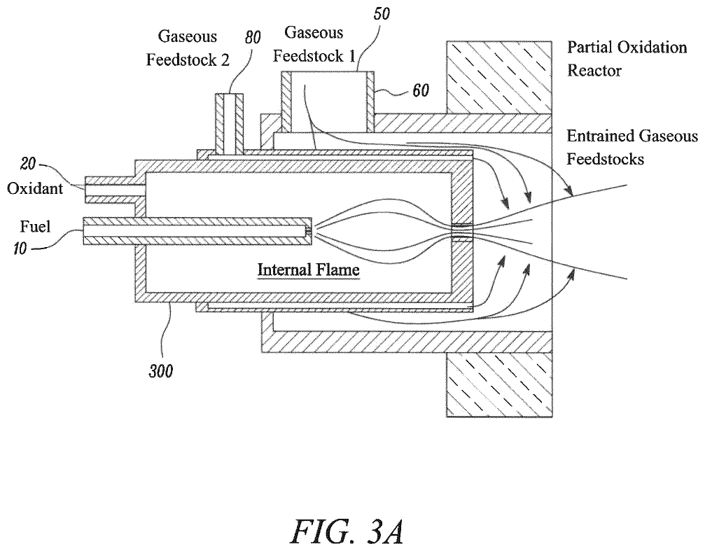

In another exemplary embodiment and with reference to FIG. 3A, multiple gaseous feedstocks (i.e., of the same or different compositions) 50 and 80 are fed symmetrically through parallel conduits 60 and 90, respectively, and are routed to the nozzle of the HOB 300 and entrained in the partial oxidation reactor. As shown in FIG. 3B, these multiple gaseous feedstock streams 50 and 80, wherein stream 50 is introduced directly into the partial oxidation reactor, while stream 80 is routed in parallel to the HOB 300 to the nozzle of HOB 300 where they are both combined in the partial oxidation reactor.

A further exemplary embodiment is shown in FIG. 4, that a multiple gaseous feedstock 50, 80 is mixed with a liquid/slurry feedstock 70, wherein the slurry feedstock stream 70 is arranged concentrically with the HOB 400 and on the outer perimeter gaseous feedstock 80 and 50, respectively, so that the liquid/slurry feedstock 70 is atomized and the gaseous feedstocks 80 and 50 are entrained in the emerging hot oxygen stream from the HOB nozzle into the partial oxidation reactor where the mixture is reformed into syngas.

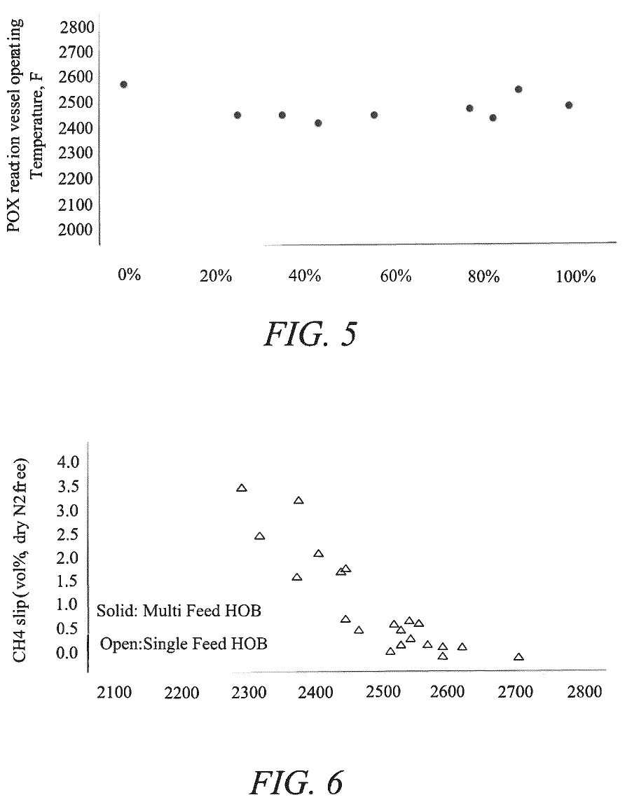

It is also important to note that an HOB designed to simultaneously gasify multiple feeds (such as illustrated in FIGS. 3A and 3B) will still maintain the ability to gasify a single feed as effectively as a burner designed for a single feed. This is illustrated in FIG. 6, which shows CH₄ slip data, a common metric of gasification efficiency, as a function of operating temperature gathered during 2 separate experimental test campaigns. The solid data points are from a test using an HOB designed to gasify gaseous and liquid feedstocks. The open data points are from several tests using an HOB designed to gasify only gaseous feedstock. The gaseous feedstock was natural gas for all tests. No liquid feedstocks were used for these tests. It is clear there is no significant difference in the amount of CH₄ slip for either burner type, indicating that the gasification performance is identical.

One aspect of the present invention is the ability to optimize the composition of the product gas by selection of the feedstocks in the mixture. For example, gasification of many solid feedstocks are known to produce syngas with a lower H₂:CO ratio. Addition of a high H:CO ratio feedstock, such as natural gas, to the feedstocks fed to the reactor results in an increase in the H₂:CO ratio.

To illustrate the ability of how hot oxygen technology can be used as described above, a set of example cases has been defined and explored. HOT performance in the partial oxidation system is estimated using a proprietary model developed by Linde to predict syngas generation and/or reforming performance. The model combines the impacts of hot oxygen jet properties on atomization and mixing of feedstocks with the reactivity of the jet and feedstock material to predict the properties of the syngas exiting the system. The model has been validated against a broad set of data that includes feedstocks such as natural gas, coke oven gas and biomass derived syngas, operating temperatures from 1100° C. to 1650° C. and operating pressures from 0 barg to 28 barg.

The examples cases show how a plant designed for normal operation with a biomass feedstock can be enhanced using the HOB. Five cases are included for evaluation, each a combination of a gaseous feedstock representative of a biomass derived syngas and liquid methanol. Use of a representative gaseous biomass derived syngas and liquid methanol was chosen to illustrate the benefits of the multi feed HOB. Other configurations and feedstocks as described above are acceptable and can be utilized in a similar way as described in these examples.

Table 1 summarizes the five cases. Case 1 represents the base case with a syngas representative of a gaseous biomass derived syngas as the primary and only feedstock. Case 2 shows how production of H₂ and CO suffer when the plant is forced to turn down operation due to issues with the biomass gasification. Case 3 shows that addition of a liquid feedstock, in this case methanol, can be used to restore the production of H₂ and CO to design levels. Case 4 shows how the production of H₂ and CO can be increased relative to case 1 by adding a liquid feed during normal operation. Case 5 shows how syngas production can be maintained when the biomass gasification system is entirely out of commission and unable to be used. The value of the operating flexibility shown through these examples will be obvious to those familiar with the operation of chemical plants utilizing biomass gasifiers.

Because the properties of the biomass feedstock and methanol are different the syngas produced by the HOB system will be different in some aspects. For example, comparing the H₂:CO ratio in case 1 and case 5 show that for this representative biomass derived syngas the H₂:CO ratio is 1.16, whereas the H₂:CO ratio for methanol is 1.5. Similarly O₂ and fuel usage, and operating temperature will also be different. The examples assume operation optimized to maximize H₂+CO production, as indicated by the amount of CH₄ slip in the conditioned syngas. These differences are operational and as long as the plant is designed for the range of possible operation will not require expensive downtime or mechanical changes to accommodate.

TABLE 1
Example operating cases

| | | Case | | | | |
|---|---|---|---|---|---|---|
| | | 1 | 2 | 3 | 4 | 5 |
| | | Operating Goal | | | | |
| | | | | Abnormal: | Abnormal: | |
| | | Normal | Abnormal: | Biomass | Increase | Abnormal: |
| | | Operation | Biomass | Turndown + | Syngas | Methanol |
| Summary | | Biomass | Turndown | Methanol | Yield | Only |
| Feed Syngas | % of design | 100% | 55% | 55% | 100% | 0% |
| Feed | % of design | 0% | 0% | 56% | 56% | 100% |
| Methanol | | | | | | |
| O2 usage | scf/scf Feed | 0.22 | 0.20 | 0.30 | 0.28 | 0.49 |
| Fuel usage | scf/scf Feed | 0.02 | 0.02 | 0.03 | 0.03 | 0.05 |
| H2 + CO | scf/scf Feed | 0.98 | 0.81 | 1.22 | 1.22 | 2.22 |
| | % of design | 100% | 46% | 100% | 155% | 100% |
| H2:CO | | 1.16 | 1.01 | 1.20 | 1.25 | 1.50 |
| T operation | ° C. | 1371 | 1329 | 1357 | 1385 | 1371 |
| CH4 slip | vol % | 0.2% | 0.2% | 0.2% | 0.2% | 0.2% |

The momentums of the hot oxygen stream and of the feed, should be sufficiently high to achieve desired levels of mixing of the oxygen and all the feed streams. The momentum flux ratio of the hot oxygen stream to the feedstock stream should be at least 3.0.

The composition of the hot oxygen stream depends on the conditions under which the stream is generated, but preferably it contains at least 50 vol. % O₂ and more preferably at least 65 vol. % O₂. The formation of the high velocity hot oxygen stream can be carried out in accordance with the description in U.S. Pat. No. 5,266,024.

Typical values of properties of the hot oxygen jet often lie in the following ranges:
Temperature: 2000-4700° F.
Velocity: 500-4500 ft/s, preferably 1950-2625 ft/s
O₂ content: 50-90%
O₂ flow rate of 1-50 kg/s

Typical values of partial oxidation conditions often lie in the following ranges: Temperature in the POx reactor: 2550° F., but as low as 2400° F. 2100° F. and as high as 2650° F.-3200° F.
Residence time in the POx reactor; 2-10 sec
Pressure in the POx reactor: atmospheric to 600 psig—but can be as high as the process requires.
Pressure is usually set on the basis of downstream processing requirement or limitations of the biomass gasifier feeding system.
Specific oxygen consumption in the partial oxidation will vary based on the composition of the feedstock (which is widely variable) and is highly correlated to temperature.
Ratio of oxygen in the hot oxygen jet used in the partial oxidation to the feed: This depends on HSR, which is described below.
Entrainment rate of the feedstock into the hot oxygen jet: This depends on both the HOB properties and the properties of the feedstock stream being entrained into the jet. For example, a less dense feed (one that is hotter or when operating at lower pressure) will entrain less rapidly than a dense feed.

Typical values of the conditions in the hot oxygen generator to produce the hot oxygen stream often lie in the following ranges:
HSR in the hot oxygen generator: preferably 3-6, but could be as high as 20.
Temperature of the oxygen that is fed to the hot oxygen generator: ambient −400° F.

Typical characteristics of the syngas produced by the POx reactor often lie in the following ranges:
Temperature: 2550° F., but as low as 2100° F. and as high as 3200° F.
Soot content: 0-0.02 gm/Nm3
CH₄ content: 0-1%, preference is as low as possible, but reactor T will limit how far it can be reduced. Usually end up operating around 0.5%.
Tar content: 0 gm/Nm3—cannot tolerate any tars, which would eventually deposit on downstream equipment and stop operation.

While the invention has been described in detail with reference to specific embodiments thereof, it will become apparent to one skilled in the art that various changes and modifications can be made, and equivalents employed, without departing from the scope of the appended claims.

What is claimed is:

1. A process for producing syngas in a partial oxidation reactor operating with a hot oxygen burner, comprising:
introducing a carbonaceous feedstock comprising a combination of gas, liquid and solid components in various combinations into a partial oxidation reactor vessel, wherein the feedstock is contacted by a hot oxygen stream produced by a hot oxygen burner wherein said hot oxygen stream is high velocity and reactive to atomize a carbonaceous feedstock selected from gas, liquid or solids in various volumetric combinations and provided through one or more passages to the hot oxygen burner and partially oxidize the feedstock in the partial oxidation reactor, using said hot oxygen jet that has given values of its temperature, velocity, and O₂ content, at given partial oxidation conditions of temperature ranging from 1100° C. to 1650° C., residence time, pressure, specific oxygen consumption, ratio of oxygen in the hot oxygen jet used in the partial oxidation to the feed, and entrainment rate of the feedstock into the hot oxygen jet wherein the hot oxygen jet is produced by reaction of oxygen and fuel in said hot oxygen burner at an HSR ranging from 3 to 12 to produce syngas having given values of temperature, soot content, CH₄ content, and tar content.

2. The process of claim 1, wherein the feedstock is a combination of a liquid feedstock component selected from the group consisting of pyoil, ethanol, plastic derived oil, heavy petroleum oils and slurries and a gaseous feedstock component selected from the group consisting of natural gas, biogas, raw syngas derived from biomass gasification, and hydrocarbon containing gases from petroleum product production wherein the liquid to gaseous ratio varies from 0 to 100 volume percent.

3. The process of claim 2, wherein the feedstock includes a solid feedstock component selected from the group consisting of coal, biomass, municipal solid waste and agricultural waste.

4. The process of claim 1, wherein the hot oxygen jet has a velocity ranging from 500-800 m/s.

5. The process of claim 1, wherein the hot oxygen jet has a concentration of oxygen ranging from 65-90 percent by volume.

6. The process of claim 1, wherein the hot oxygen burner is operated with a flow rate between 1-50 kg/s of oxygen.

7. The process of claim 1, wherein the reactor vessel is operated at a pressure between 1-50 bar.

8. The process of claim 1, wherein the syngas is further processed to produce chemicals, such as ammonia, methanol or synthetic fuels.
